(19) United States
(12) Patent Application Publication
(10) Pub. No.: US 2023/0238161 A1
(43) Pub. Date: Jul. 27, 2023

(54) METHOD FOR PRODUCING ANISOTROPIC MAGNETIC POWDER, AND ANISOTROPIC MAGNETIC POWDER

(71) Applicant: NICHIA CORPORATION, Anan-shi (JP)

(72) Inventor: Hisashi MAEHARA, Itano-gun (JP)

(73) Assignee: NICHIA CORPORATION, Anan-shi (JP)

(21) Appl. No.: 18/002,272

(22) PCT Filed: Jun. 16, 2021
(86) PCT No.: PCT/JP2021/022875

§ 371 Date: Dec. 18, 2022

(30) Foreign Application Priority Data
Jun. 19, 2020 (JP) 2020-106311

(51) Int. Cl. H01F 1/059; H01F 1/06; B22F 9/22; B22F 1/145; B22F 9/10

(52) U.S. Cl. CPC H01F 1/059; H01F 1/065; B22F 9/22; B22F 1/145; B22F 9/10; B22F 2304/10

(57) ABSTRACT

Provided is an anisotropic magnetic powder having a low oxygen concentration, a small average particle size, a narrow particle size distribution, and a high remanence, and a method for producing the anisotropic magnetic powder. The present disclosure relates to a method for producing an anisotropic magnetic powder, including: pretreating an oxide containing Sm and Fe by heat-treating the oxide in a reducing gas atmosphere to obtain a partial oxide; heat-treating the partial oxide in the presence of a reducing agent to obtain alloy particles; nitriding the alloy particles to obtain a nitride; and treating the nitride with an alkali to obtain a magnetic powder.

### TECHNICAL FIELD

The present invention relates to a method for producing an anisotropic magnetic powder and an anisotropic magnetic powder.

### BACKGROUND ART

Patent Literature 1 discloses a SmFeN-based sintered magnet in which sintering is performed with a magnetic powder having a small average particle size and a low oxygen content. However, the magnetic powder is prepared by grinding a magnetic powder having an average particle size of 20 μm or more in a jet mill, resulting in the production of only a powder having a wide particle size distribution.

Meanwhile, Patent Literature 2 discloses a method of washing a magnetic powder, which is prepared by nitridation, with an acid to remove the calcium used in a reduction diffusion step. However, the purpose of this method is to remove calcium, and the literature discloses only a magnetic powder having a high oxygen content at least in the examples.

### CITATION LIST

### Patent Literature

Patent Literature 1: JP 2017-55072A

Patent Literature 2: JP 2015-70102 A

### SUMMARY OF INVENTION

### Technical Problem

The present invention aims to provide an anisotropic magnetic powder having a low oxygen concentration, a small average particle size, a narrow particle size distribution, and a high remanence, and a method for producing the anisotropic magnetic powder.

### Solution to Problem

Embodiments of the present invention relate to a method for producing an anisotropic magnetic powder, including:

pretreating an oxide containing Sm and Fe by heat treatment in a reducing gas atmosphere to obtain a partial oxide;

heat-treating the partial oxide in the presence of a reducing agent to obtain alloy particles;

nitriding the alloy particles to obtain a nitride; and

treating the nitride with an alkali to obtain a magnetic powder.

Further embodiments of the present invention relate to an anisotropic magnetic powder,

the powder having an average particle size of at least 1.5 μm but not more than 7 μm as measured with a laser diffraction-type particle size distribution analyzer under dry conditions,

the powder having a span of not more than 1.6 as defined by the following equation:

Span=(D90−D10)/D50

wherein D10, D50, and D90 represent particle sizes corresponding to 10th, 50th, and 90th percentiles, respectively, in a cumulative particle size distribution by volume, and

the powder containing Sm, Fe, N, and O and having an O content of at least 0.05% by mass but not higher than 0.65% by mass.

### Advantageous Effects of Invention

The method for producing an anisotropic magnetic powder according to the present invention includes treating a nitride with an alkali and thus enables the production of an anisotropic magnetic powder having a low oxygen concentration, a small average particle size, a narrow particle size distribution, and a high remanence.

### DESCRIPTION OF EMBODIMENTS

Embodiments of the present invention are described in detail below. The following embodiments, however, are intended as examples to embody the technical idea of the present invention and are not intended to limit the scope of the present invention to the following embodiments. As used herein, the term “step” encompasses not only an independent step but also a step that may not be clearly distinguished from other steps, as long as a desired object of the step is achieved. Moreover, numerical ranges indicated using “to” refer to ranges including the numerical values indicated before and after “to” as the minimum and maximum, respectively.

A first method for producing an anisotropic magnetic powder according to the present embodiments includes: pretreating an oxide containing Sm and Fe by heat treatment in a reducing gas atmosphere to obtain a partial oxide; heat-treating the partial oxide in the presence of a reducing agent to obtain alloy particles; nitriding the alloy particles to obtain a nitride; and treating the nitride with an alkali to obtain a magnetic powder. If the unreacted metallic calcium contained in the nitride or the by-product calcium nitride is treated with water, heat generation and oxidation associated with heat generation occur. However, such heat generation and oxidation associated with heat generation can be reduced by treatment with an alkali solution instead of water. Thus, it is possible to produce a magnetic powder having a low oxygen concentration, a small average particle size, a narrow particle size distribution, and a high remanence.

### Pretreatment Step

The oxide containing Sm and Fe used in the pretreatment step may be prepared by mixing a Sm oxide and a Fe oxide, for example. Alternatively, it can be prepared by mixing a solution containing Sm and Fe with a precipitating agent to obtain a precipitate containing Sm and Fe (precipitation step), and calcining the precipitate to obtain an oxide containing Sm and Fe (oxidation step).

### Precipitation Step

In the precipitation step, a Sm source and a Fe source may be dissolved in a strongly acidic solution to prepare a solution containing Sm and Fe. When the main phase to be obtained is Sm₂Fe₇N₃, the molar ratio of Sm and Fe (Sm:Fe) is preferably 1.5:17 to 3.0:17, more preferably 2.0:17 to 2.5:17. La, W, Co, Ti, Sc, Y, Pr, Nd, Pm, Gd, Tb, Dy, Ho, Er, Tm, Lu, or other sources may be added to the solution. In view of remanence, the solution preferably contains La. In view of coercive force and squareness ratio, the solution preferably contains W. In view of temperature characteristics, the solution preferably contains Co or Ti.

Any Sm or Fe source soluble in a strongly acidic solution may be used. In view of availability, examples of the Sm source include samarium oxide, and examples of the Fe source include FeSO₄. The concentration of the solution containing Sm and Fe may be appropriately adjusted within a range in which the Sm source and the Fe source can be substantially dissolved in an acidic solution. In view of solubility, examples of the acidic solution include sulfuric acid.

The solution containing Sm and Fe may be reacted with a precipitating agent to obtain an insoluble precipitate containing Sm and Fe. Here, the solution containing Sm and Fe is not limited as long as Sm and Fe are present in the solution during the reaction with the precipitating agent. For example, sources respectively containing Sm and Fe may be prepared as separate solutions and individually added dropwise to react with the precipitating agent. When separate solutions are prepared, the concentration of each solution may also be appropriately adjusted within a range in which the corresponding source can be substantially dissolved in an acidic solution. The precipitating agent may be any alkaline solution that reacts with a solution containing Sm and Fe to give a precipitate. Examples include ammonia water and caustic soda, with caustic soda being preferred.

To easily control the particle properties of the precipitate, the precipitation reaction is preferably performed by adding dropwise each of the solution containing Sm and Fe and the precipitating agent to a solvent such as water. A precipitate having a homogeneous element distribution, a narrow particle size distribution, and a uniform particle shape can be obtained by appropriately controlling the feeding rates of the solution containing Sm and Fe and the precipitating agent, the reaction temperature, the concentration of the reaction solution, the pH during the reaction, and other conditions. The use of such a precipitate improves the magnetic properties of the finally produced magnetic powder. The reaction temperature is 0° C. to 50° C., preferably 35° C. to 45° C. The concentration of the reaction solution calculated as the total concentration of metal ions is preferably 0.65 to 0.85 mol/L, more preferably 0.7 to 0.85 mol/L. The reaction pH is preferably 5 to 9, more preferably 6.5 to 8.

In view of magnetic properties, the solution containing Sm and Fe preferably further contains at least one metal selected from the group consisting of La, W, Co, and Ti. For example, in view of remanence, the solution preferably contains La. In view of coercive force and squareness ratio, the solution preferably contains W. In view of temperature characteristics, the solution preferably contains Co or Ti. The La source is not limited as long as it is soluble in a strongly acidic solution. In view of availability, examples include La₂O₃ and LaCl₃. The concentration may be appropriately adjusted within a range in which the Sm and Fe sources and the La, W, Co, and/or Ti source can be substantially dissolved in an acidic solution. In view of solubility, examples of the acidic solution include sulfuric acid. The W source may be ammonium tungstate, the Co source may be cobalt sulfate, and the Ti source may be sulfated titania. These sources are each preferably prepared separately from the solution containing Sm and Fe and at a concentration within a range in which they can be substantially dissolved in water.

When the solution containing Sm and Fe further contains at least one metal selected from the group consisting of La, W, Co, and Ti, an insoluble precipitate containing Sm, Fe, and at least one selected from the group consisting of La, W, Co, and Ti will be produced. Here, the solution is not limited as long as at least one selected from the group consisting of La, W, Co, and Ti is present during the reaction with the precipitating agent. For example, the sources may be prepared as separate solutions and individually added dropwise to react with the precipitating agent. Alternatively, they may be prepared together with the solution containing Sm and Fe.

The anisotropic magnetic powder particles obtained in the precipitation step roughly determine the powder particle size, particle shape, and particle size distribution of the finally produced magnetic powder. When the particle size of the obtained particles is measured with a laser diffraction-type wet particle size distribution analyzer, the size and distribution of all the particles preferably substantially fall within the range of 0.05 to 20 μm, preferably 0.1 to 10 μm. Moreover, the average particle size of the anisotropic magnetic powder particles is determined as the particle size corresponding to the 50th percentile in the cumulative undersize particle size distribution by volume. The average particle size is preferably within the range of 0.1 to 10 μm.

After separating the precipitate, the separated precipitate is preferably subjected to solvent removal in order to reduce changes in properties such as particle size distribution and powder particle size and aggregation of the precipitate caused by evaporation of the residual solvent in which the precipitate has been re-dissolved during the heat treatment in the subsequent oxidation step. Specifically, when the solvent used is water, for example, the solvent removal may be performed by drying in an oven at 70° C. to 200° C. for 5 to 12 hours.

The precipitation step may be followed by washing and separating the resulting precipitate. The step of washing may be appropriately performed until the conductivity of the supernatant solution reaches 5 mS/m² or lower. The step of separating the precipitate may be performed, for example, by mixing the precipitate with a solvent (preferably water), followed by filtration, decantation, or other separation methods.

### Oxidation Step

The oxidation step includes calcining the precipitate formed in the precipitation step to obtain an oxide containing Sm and Fe. For example, the precipitate may be converted into an oxide by heat treatment. The heat treatment of the precipitate needs to be performed in the presence of oxygen, for example in an air atmosphere. Moreover, since the presence of oxygen is necessary, the non-metal portion of the precipitate preferably contains an oxygen atom.

The heat treatment temperature in the oxidation step (hereinafter, oxidation temperature) is not limited, but is preferably 700° C. to 1,300° C., more preferably 900° C. to 1,200° C. When the temperature is lower than 700° C., the oxidation tends to be insufficient. When the temperature is higher than 1,300° C., the resulting magnetic powder tends not to have the target particle shape, average particle size, and particle size distribution. The heat treatment duration is not limited either, but is preferably 1 to 3 hours.

The thus formed oxide is oxide particles in which R and iron have been sufficiently microscopically mixed, and the particle shape, particle size distribution, and other properties of the precipitate have been reflected.

### Pretreatment Step

The pretreatment step includes subjecting the oxide containing Sm and Fe to heat treatment in a reducing gas atmosphere to obtain a partial oxide which is a partially reduced product of the oxide.

Here, the term “partial oxide” refers to a partially reduced oxide. The oxygen concentration of the oxide is not limited, but is preferably not more than 10% by mass, more preferably not more than 8% by mass. When the concentration is more than 10% by mass, the heat generated by reduction with Ca in the reduction step tends to increase, raising the calcination temperature enough to form abnormally grown particles. Here, the oxygen concentration of the partial oxide can be measured by non-dispersive infrared spectroscopy (ND-IR).

The reducing gas may be appropriately selected from hydrogen (H₂), carbon monoxide (CO), hydrocarbon gases such as methane (CH₄), and other gases. Hydrogen gas is preferred in terms of cost. The flow rate of the gas may be appropriately adjusted within a range that does not cause scattering of the oxide. The heat treatment temperature in the pretreatment step (hereinafter, pretreatment temperature) is preferably at least 300° C. but not higher than 950° C. The lower limit is more preferably at least 400° C., still more preferably at least 750° C. The upper limit is more preferably lower than 900° C. When the pretreatment temperature is at least 300° C., reduction of the oxide containing Sm and Fe can efficiently proceed. Moreover, when the pretreatment temperature is not higher than 950° C., the grain growth and segregation of the oxide particles can be inhibited so that the desired particle size can be maintained. Moreover, when the reducing gas used is hydrogen, preferably the thickness of the oxide layer used is adjusted to not more than 20 mm, and further the dew point in the reaction furnace is adjusted to not higher than −10° C.

### Reduction Step

The reduction step includes heat-treating the partial oxide in the presence of a reducing agent to obtain alloy particles. For example, the reduction may be performed by allowing the partial oxide to contact with molten calcium or calcium vapor. In view of magnetic properties, the heat treatment temperature is preferably at least 920° C. but not higher than 1,200° C., more preferably at least 950° C. but not higher than 1,150° C., still more preferably at least 980° C. but not higher than 1,100° C.

As an alternative to the above-mentioned heat treatment process in the reduction step, heat treatment may be performed at a first temperature of at least 1,000° C. but not higher than 1,090° C., and then at a second temperature lower than the first temperature which is at least 980° C. but not higher than 1,070° C. The first temperature is preferably at least 1,010° C. but not higher than 1,080° C., and the second temperature is preferably at least 990° C. but not higher than 1,060° C. With regard to the difference between the first temperature and the second temperature, the second temperature is preferably lower than the first temperature by at least 15° C. but not more than 60° C., more preferably by at least 15° C. but not more than 30° C. The heat treatment at the first temperature and the heat treatment at the second temperature may be continuously performed. Although there may be a heat treatment at a temperature lower than the range of the second temperature between these heat treatments, it is preferred in view of productivity to perform these treatments continuously. To perform a more uniform reduction reaction, the duration of each heat treatment is preferably shorter than 120 minutes, more preferably shorter than 90 minutes. The lower limit of the heat treatment duration is preferably not shorter than 10 minutes, more preferably not shorter than 30 minutes.

The metallic calcium may be used in the form of granules or powder, and its particle size is preferably 10 mm or less. This can more effectively reduce aggregation during the reduction reaction. Moreover, the metallic calcium is preferably added in an amount that is 1.1 to 3.0 times, more preferably 1.5 to 2.5 times the reaction equivalent (which is the stoichiometric amount needed to reduce the rare earth oxides, including the amount needed to reduce Fe, if present in the form of an oxide).

In the reduction step, the metallic calcium as a reducing agent may be used in combination with a disintegration accelerator, if necessary. The disintegration accelerator may be appropriately used to facilitate the disintegration or granulation of the product during the alkali treatment step described later. Examples include alkaline earth metal salts such as calcium chloride, and alkaline earth oxides such as calcium oxide. Such disintegration accelerators may be used in an amount of 1 to 30% by mass, preferably 5 to 30% by mass, relative to the amount of the rare earth oxides used as rare earth sources.

### Nitridation Step

The nitridation step includes nitriding the alloy particles obtained in the reduction step to obtain anisotropic magnetic particles. Since the particulate precipitate obtained in the precipitation step is used, the alloy particles obtained in the reduction step are in porous bulk form. This permits the alloy particles to be directly nitrided by heat treatment in a nitrogen atmosphere without grinding, resulting in uniform nitridation.

The heat treatment temperature in the nitridation of the alloy particles (hereinafter, nitridation temperature) is preferably adjusted to 300° C. to 600° C., particularly preferably 400° C. to 550° C., and the atmosphere may be replaced with nitrogen to perform heat treatment in this temperature range. The heat treatment duration may be set so that the alloy particles can be sufficiently uniformly nitrided.

### Alkali Treatment Step

In some cases, the product obtained after the nitridation step contains, in addition to the magnetic particles, contaminants such as by-product Ca₃N₂, CaO, and unreacted metallic calcium, and forms a composite with these contaminants in a sintered bulk form. Thus, such a product may be introduced into an alkali solution to separate the Ca₃N₂, CaO, and metallic calcium as a suspension of calcium hydroxide (Ca(OH)₂) from the magnetic particles. Further, the residual calcium hydroxide may be sufficiently removed by washing the magnetic particles with acetic acid or the like.

Examples of the alkali solution used in the alkali treatment step include an aqueous solution containing calcium hydroxide, an aqueous solution containing sodium hydroxide, and an aqueous solution containing ammonia. In view of wastewater treatment and high pH, an aqueous solution containing calcium hydroxide or an aqueous solution containing sodium hydroxide is preferred among these.

The pH of the alkali solution used in the alkali treatment step is not limited, but is preferably not less than 9, more preferably not less than 10. When the pH is less than 9, the rate of the reaction into calcium hydroxide is high, causing more heat generation. Thus, the oxygen concentration tends to increase.

In the alkali treatment step, the magnetic powder obtained after the alkali treatment may optionally be subjected to decantation or other techniques to reduce the moisture content.

### Acid Treatment Step

The alkali treatment step is preferably followed by treatment with an acid. Although the calcium components are removed by the alkali treatment of the nitride, the remaining Sm-rich layer containing a certain amount of oxygen serves as a protection layer to reduce an increase in oxygen concentration caused by oxidation. In the acid treatment step, the aforementioned Sm-rich layer may be removed to reduce the oxygen concentration of the magnetic powder as a whole. Moreover, since the production method according to the embodiments of the present invention does not include grinding or the like, the anisotropic magnetic powder has a small average particle size and a narrow particle size distribution, and also does not contain fine particles, which makes it possible to reduce an increase in oxygen concentration.

Any acid may be used in the acid treatment step. Examples include hydrogen chloride, nitric acid, sulfuric acid, and acetic acid. To avoid residual impurities, hydrogen chloride or nitric acid is preferred among these.

The amount of the acid used in the acid treatment step per 100 parts by mass of the magnetic powder is preferably at least 3.5 parts by mass but not more than 13.5 parts by mass, more preferably at least 4 parts by mass but not more than 10 parts by mass. When the amount is less than 3.5 parts by mass, the oxide tends to remain on the surface of the magnetic powder to increase the oxygen concentration. When the amount is more than 13.5 parts by mass, oxidation is likely to occur upon contacting the air, and also the cost tends to increase because the acid dissolves the magnetic powder.

In the acid treatment step, the magnetic powder obtained after the treatment with an acid may optionally be subjected to decantation or other techniques to reduce the moisture content.

### Dehydration Step

The acid treatment step is preferably followed by dehydration. Dehydration can reduce the moisture content of the solids before vacuum drying, thereby inhibiting the progress of oxidation during drying due to the higher moisture content of the solids before vacuum drying. Here, the term “dehydration” refers to a treatment in which a pressure or a centrifugal force is applied to reduce the moisture content of the solids after the treatment as compared to that before the treatment, and excludes mere decantation, filtration, or drying. The dehydration may be performed by any method such as squeezing or centrifugation.

Although the moisture content of the magnetic powder after the dehydration is not limited, it is preferably not higher than 13% by mass, more preferably not higher than 10% by mass, in order to inhibit the progress of oxidation.

The magnetic powder obtained by acid treatment or the magnetic powder obtained by acid treatment followed by dehydration is preferably dried in vacuum. The drying temperature is not limited, but is preferably not lower than 70° C., more preferably 80° C. The drying duration is not limited either, but is preferably not shorter than 1 hour, more preferably not shorter than 3 hours.

Embodiments of the present invention relate to a method for producing an anisotropic magnetic powder, including:

pretreating an oxide containing Sm and Fe by heat treatment in a reducing gas atmosphere to obtain a partial oxide;

heat-treating the partial oxide in the presence of a reducing agent at least 920° C. but not higher than 1,200° C. to obtain alloy particles;

nitriding the alloy particles to obtain a nitride;

washing the nitride to obtain a magnetic powder; and

treating the magnetic powder with an acid, wherein the amount of the acid per 100 parts by mass of the magnetic powder is at least 3.5 parts by mass but not more than 13.5 parts by mass.

The second method for producing an anisotropic magnetic powder according to the present embodiments includes: pretreating an oxide containing Sm and Fe by heat treatment in a reducing gas atmosphere to obtain a partial oxide; heat-treating the partial oxide in the presence of a reducing agent at least 920° C. but not higher than 1,200° C. to obtain alloy particles; nitriding the alloy particles to obtain a nitride; washing the nitride to obtain a magnetic powder; and treating the magnetic powder with an acid, wherein the amount of the acid per 100 parts by mass of the magnetic powder is at least 3.5 parts by mass but not more than 13.5 parts by mass. When the amount of the acid used in the acid treatment step is at least 3.5 parts by mass but not more than 13.5 parts by mass per 100 parts by mass of the magnetic powder, the surface of the magnetic powder can be coated with a Sm-rich layer which is oxidized enough to inhibit reoxidation upon exposure to the air after the acid treatment. Thus, the resulting anisotropic magnetic powder has a low oxygen concentration, a small average particle size, and a narrow particle size distribution. Here, the pretreatment step, the step of obtaining alloy particles, the step of obtaining a nitride, and the step of treatment with an acid are as described above. Dehydration and dispersion may be performed as in the first production method.

Embodiments of the present invention relate to an anisotropic magnetic powder which has an average particle size of at least 1.5 μm but not more than 7 μm as measured with a laser diffraction-type particle size distribution analyzer under dry conditions, and has a span of not more than 1.6 as defined by the following equation:

Span=(D90−D10)/D50

wherein D10, D50, and D90 represent the particle sizes corresponding to the 10th, 50th, and 90th percentiles, respectively, in the cumulative particle size distribution by volume, and which contains Sm, Fe, N, and O and has an O content of at least 0.05% by mass but not higher than 0.65% by mass.

The anisotropic magnetic powder according to the present embodiments can be produced by the above-mentioned production methods, for example. Since the production methods do not include mechanical crushing (e.g., grinding) of the magnetic powder, the produced anisotropic magnetic powder has a low oxygen concentration, a small average particle size, a narrow particle size distribution (a small span), and a high remanence.

The anisotropic magnetic powder according to the present embodiments is typically represented by the following formula:

SmᵥFe_{(100-v-w-x-y-z-u)}N_{w}LaₓW_{y}Co_{z}Tiᵤ

wherein 3≤v≤30, 5≤w≤15, 0≤x≤0.3, 0≤y≤2.5, 0≤z≤2.5, and 0≤u≤2.5.

In the formula, v is defined to be at least 3 but not more than 30 for the following reason. If v is less than 3, the unreacted iron component (α-Fe phase) may be separated, which reduces the coercive force of the nitride so as to fail to provide a practical magnet, while if v is more than 30, the Sm element may precipitate and make the magnetic powder unstable in the air, thereby reducing the remanence. Moreover, w is defined to be at least 5 but not more than 15 for the following reason. If w is less than 5, almost no coercive force may be obtained, while if w is more than 15, a nitride of the Sm element or iron itself may be formed.

The average particle size of the anisotropic magnetic powder is at least 1.5 μm but not more than 7 μm, preferably at least 3 μm but not more than 7 μm, more preferably at least 4 μm but not more than 6.5 μm. The magnetic powder having an average particle size of less than 1.5 μm has a large surface area and is thus more likely to be oxidized. The magnetic powder having an average particle size of more than 7 μm tends to have a multidomain structure, resulting in lower magnetic properties. Here, the term “average particle size” refers to the particle size measured using a laser diffraction-type particle size distribution analyzer under dry conditions.

The anisotropic magnetic powder has a span of not more than 1.6, preferably not more than 1.3 as calculated by the following equation:

Span=(D90−D10)/D50

wherein D10, D50, and D90 represent the particle sizes corresponding to the 10th, 50th, and 90th percentiles, respectively, in the cumulative particle size distribution by volume. When the span is more than 1.6, large particles are present, so that the magnetic properties tend to be lowered.

It is sufficient that the anisotropic magnetic powder contains oxygen and its oxygen content is at least 0.05% by mass but not higher than 0.65% by mass, preferably not higher than 0.3% by mass. The anisotropic magnetic powder having an oxygen content of lower than 0.05% by mass is more likely to be oxidized upon exposure to the air. The anisotropic magnetic powder having an oxygen content of higher than 0.65% by mass tends to have lower magnetic properties. Here, the oxygen content can be measured by non-dispersive infrared spectroscopy (ND-IR).

The average circularity of the anisotropic magnetic powder is preferably not less than 0.50, more preferably not less than 0.70, particularly preferably not less than 0.75. When the circularity is less than 0.50, the fluidity may deteriorate so that stress can occur between the particles during the magnetic field compaction, resulting in lower magnetic properties. The circularity may be determined using a scanning electron microscope and a particle analysis Ver. 3 available from Sumitomo Metal Technology, Inc. as image analysis software. The circularity may be determined by taking a SEM image at a magnification of 3,000, processing the image for binarization, and calculating the circularity of each particle. The term “circularity” defined in the present invention refers to the average of the circularities obtained by measuring about 1,000 to 10,000 particles. In general, the larger the number of small size particles, the higher the circularity. Hence, particles having a particle size of not less than 1 μm are measured for circularity. The circularity measurement uses the definitional equation: Circularity=4 πS/L², wherein S represents the area of the two-dimensional projection of the particle, and L represents the perimeter of the two-dimensional projection thereof.

The anisotropic magnetic powder of the present embodiments has a low oxygen concentration and thus can be used for sintered magnets or bonded magnets, for example.

A bonded magnet may be produced from the anisotropic magnetic powder according to the present embodiments and a resin. The inclusion of the anisotropic magnetic powder enables production of a composite material having high magnetic properties.

The resin contained in the composite material may be either a thermosetting resin or a thermoplastic resin, preferably a thermoplastic resin. Specific examples of the thermoplastic resin include polyphenylene sulfide resins (PPS), polyether ether ketones (PEEK), liquid crystal polymers (LCP), polyamides (PA), polypropylenes (PP), and polyethylenes (PE).

The mass ratio of the resin to the anisotropic magnetic powder (resin/magnetic powder) in the production of the composite material is preferably 0.10 to 0.15, more preferably 0.11 to 0.14.

For example, the composite material may be obtained by mixing the anisotropic magnetic powder and the resin using a kneader at 280° C. to 330° C.

The composite material may be used to produce a bonded magnet. Specifically, for example, a bonded magnet may be produced by heat-treating the composite material to align the easy axes of magnetization in an orientation field (orientation step), followed by pulse magnetization in a magnetizing field (magnetization step).

The heat treatment temperature in the orientation step is preferably, for example, 90° C. to 200° C., more preferably 100° C. to 150° C. The magnitude of the orientation field in the orientation step may be, for example, 720 kA/m. Moreover, the magnitude of the magnetizing field in the magnetization step may be, for example, 1500 to 2500 kA/m.

A sintered magnet may be produced by compacting and sintering the anisotropic magnetic powder according to the present embodiments.

The anisotropic magnetic powder according to the present embodiments, which has a low oxygen concentration, a small average particle size, a narrow particle size distribution, and a high remanence, is suitable for sintered magnets.

For example, a sintered magnet may be produced by sintering the magnetic powder in an atmosphere with an oxygen concentration of not more than 0.5 ppm by volume at a temperature of higher than 300° C. but lower than 600° C. under a pressure of at least 1,000 MPa but not more than 1,500 MPa, as described in JP 2017-055072A.

For example, a sintered magnet may be produced by pre-compacting the magnetic powder in a magnetic field of not lower than 6 kOe, followed by warm compaction at a temperature of not higher than 600° C. and a contact pressure of 1 to 5 GPa, as described in WO2015/199096.

For example, a sintered magnet may be produced by subjecting a mixture containing the magnetic powder and a metal binder to cold compaction at a contact pressure of 1 to 5 GPa, followed by heating at a temperature of 350° C. to 600° C. for 1 to 120 minutes, as described in JP 2016-082175A.

### EXAMPLES

Examples are described below. It should be noted that “%” is by mass unless otherwise specified.

### Evaluation

The oxygen content, nitrogen content, and particle size distribution were evaluated as described below.

### Oxygen Content

The oxygen content was measured by non-dispersive infrared spectroscopy (EMGA-820 available from Horiba Ltd.).

### Nitrogen Content

The nitrogen content was measured by a thermal conductivity method (EMGA-820 available from Horiba Ltd.).

### Particle Size Distribution

The particle size distribution was measured with a laser diffraction-type particle size distribution analyzer (HELOS & RODOS available from Japan Laser Corporation).

### Moisture Content

The moisture content was determined from the difference in weight before and after vacuum drying.

### Production Example 1 (Production of Middle Particle Size SmFe Oxide)

An amount of 5.0 kg of FeSO₄·7H₂O was mixed and dissolved in 2.0 kg of pure water. To the mixture were further added 0.49 kg of Sm₂O₃, 0.035 kg of La₂O₃, and 0.74 kg of 70% sulfuric acid, and they were well stirred and completely dissolved. Next, pure water was added to the resulting solution so that the final Fe and Sm concentrations were adjusted to 0.726 mol/L and 0.112 mol/L, respectively, to obtain a SmFeLa sulfuric acid solution.

### Precipitation Step

The entire amount of the prepared SmFeLa sulfuric acid solution was added dropwise to 20 kg of pure water kept at a temperature of 40° C. with stirring over 70 minutes from the start of the reaction, while simultaneously adding dropwise a 15% ammonia solution to adjust the pH to 7 to 8. Thus, a slurry containing a SmFeLa hydroxide was obtained. The slurry was washed with pure water by decantation, followed by solid-liquid separation to separate the hydroxide. The separated hydroxide was dried in an oven at 100° C. for 10 hours.

### Oxidation Step

The hydroxide obtained in the precipitation step was calcined in the air at 1,000° C. for 1 hour. After cooling, a red SmFeLa oxide as a raw material powder was obtained.

### Production Example 2 (Production of Large Particle Size SmFe Oxide)

A middle particle size SmFe oxide was prepared by the same procedure as in Production Example 1, except that 0.035 kg of La₂O₃ was added, and the temperature in the air used in the oxidation step was changed to 900° C.

### Production Example 3 (Production of Small Particle Size SmFe Oxide)

A small particle size SmFe oxide was prepared by the same procedure as in Production Example 1, except that 0.14 kg of 18% ammonium tungstate was dropwise added together with the 15% ammonia solution, and the calcination temperature in the oxidation step was changed to 900° C.

### Example 1 (Middle Particle Size Magnetic Powder)

### Pretreatment Step

An amount of 100 g of the SmFeLa oxide obtained in Production Example 1 was put in a steel container to a thickness of 10 mm. The container was placed in a furnace, and the pressure was reduced to 100 Pa. Then, while introducing hydrogen gas, the temperature was increased to a pretreatment temperature of 850° C. and maintained at this temperature for 15 hours. The oxygen concentration was measured by non-dispersive infrared spectroscopy (ND-IR) (EMGA-820 available from Horiba Ltd.) and found to be 5% by mass. The results show that a black partial oxide was obtained in which the oxygen bonded to Sm remained unreduced while 95% of the oxygen bonded to Fe was reduced.

### Reduction Step

An amount of 60 g of the partial oxide obtained in the pretreatment step was mixed with 19.2 g of metallic calcium having an average particle size of about 6 mm, and the mixture was placed in a furnace. After vacuum evacuation of the furnace, argon gas (Ar gas) was introduced. The temperature was increased to a first temperature of 1,045° C. and maintained for 45 minutes, and then the temperature was lowered to a second temperature of 1,000° C. and maintained for 30 minutes, thereby obtaining SmFeLa alloy particles.

### Nitridation Step

Subsequently, the temperature inside the furnace was lowered to 100° C., followed by vacuum evacuation. Then, while introducing nitrogen gas, the temperature was increased to 450° C. and maintained at this temperature for 23 hours, thereby obtaining a magnetic particle-containing bulk product.

### Alkali Treatment Step

The bulk product obtained in the nitridation step was introduced into 3 kg of a 10% by weight calcium hydroxide aqueous solution (pH 12.3) and stirred for 30 minutes. After standing still, the supernatant was drained by decantation. The introduction into pure water, stirring, and decantation were repeated 10 times. Next, 2.5 g of 99.9% acetic acid was introduced and stirred for 15 minutes. After standing still, the supernatant was drained by decantation. The introduction into pure water, stirring, and decantation were repeated twice. After solid-liquid separation, vacuum drying was performed at 80° C. for 3 hours to obtain a magnetic powder.

### Example 2 (Middle Particle Size Magnetic Powder)

A magnetic powder was produced by the same procedure as in Example 1, except that the 10% by weight calcium hydroxide aqueous solution used in the water washing step was changed to a 10% by weight sodium hydroxide aqueous solution (pH 13.0).

### Example 3 (Middle Particle Size Magnetic Powder)

A nitride bulk product was prepared by the same procedure up to the nitridation step as in Example 1.

### Alkali Treatment Step

The bulk product was introduced into 3 kg of a 10% by weight calcium hydroxide solution (pH 12.3) and stirred for 30 minutes. After standing still, the supernatant was drained by decantation. The introduction into pure water, stirring, and decantation were repeated 10 times. Next, 2.5 g of 99.9% acetic acid was introduced and stirred for 15 minutes. After standing still, the supernatant was drained by decantation. The introduction into pure water, stirring, and decantation were repeated twice.

### Acid Treatment Step

To 100 parts by mass of the magnetic powder obtained in the previous step was added a 6% aqueous hydrochloric acid solution in an amount equivalent to 10 parts by mass of hydrogen chloride, and the mixture was stirred for 1 minute. After standing still, the supernatant was drained by decantation. The introduction into pure water, stirring, and decantation were repeated twice. After solid-liquid separation, vacuum drying was performed at 80° C. for 3 hours to obtain a magnetic powder.

### Example 4 (Middle Particle Size Magnetic Powder)

A magnetic powder was produced by the same procedure as in Example 1, except that the calcium hydroxide aqueous solution used in the water washing step in Example 3 was changed to a 10% by weight sodium hydroxide aqueous solution (pH 13.0).

### Comparative Example 1 (Middle Particle Size Magnetic Powder)

A magnetic powder was produced by the same procedure as in Example 1, except that the calcium hydroxide aqueous solution used in the water washing step was changed to pure water.

The magnetic powders obtained in the examples and comparative example were measured for oxygen content, nitrogen content, and particle size distributions as described above. Tables 1 and 2 show the evaluation results.

TABLE 1

| Example | Contact | Acid | Content (% by mass) | | | | | Composition formula | | | | |
|---|---|---|---|---|---|---|---|---|---|---|---|---|
| number | with alkali | treatment | Sm | Fe | La | O | N | Sm | Fe | La | O | N |
| Example 1 | Yes | No | 23.2 | 75.3 | 0.54 | 0.76 | 3.65 | 8.5 | 74.3 | 0.21 | 2.6 | 14.4 |
| Example 2 | Yes | No | 23.2 | 74.7 | 0.54 | 0.78 | 3.71 | 8.5 | 73.9 | 0.21 | 2.7 | 14.7 |
| Example 3 | Yes | Yes | 23.8 | 74.7 | 0.28 | 0.36 | 3.25 | 9.0 | 76.3 | 0.12 | 1.3 | 13.3 |
| Example 4 | Yes | Yes | 23.4 | 74.6 | 0.29 | 0.37 | 3.39 | 8.8 | 75.9 | 0.12 | 1.3 | 13.8 |
| Comparative | No | No | 22.6 | 75.1 | 0.44 | 0.87 | 3.76 | 8.3 | 73.8 | 0.17 | 3.0 | 14.7 |
| Example 1 | | | | | | | | | | | | |

TABLE 2

| | | Particle size distribution | | | | | |
|---|---|---|---|---|---|---|---|
| | Average | | | | Span | | |
| Example | particle size | | | | (D90-D10)/ | | or |
| number | (μm) | D10 | D50 | D90 | D50 | Circularity | (emu/g) |
| Example 1 | 3.27 | 2.31 | 4.18 | 6.88 | 1.09 | 0.79 | 121.2 |
| Example 2 | 3.32 | 2.22 | 3.96 | 6.75 | 1.14 | 0.77 | 121.5 |
| Example 3 | 3.06 | 2.12 | 3.95 | 6.24 | 1.04 | 0.78 | 141.1 |
| Example 4 | 3.04 | 2.22 | 3.84 | 6.22 | 1.04 | 0.76 | 140.8 |
| Comparative Example 1 | 3.30 | 2.31 | 4.00 | 6.72 | 1.10 | 0.77 | 119.5 |

The results in Tables 1 and 2 demonstrate that Examples 1 and 2 in which the nitride was allowed to contact with an alkali solution exhibited a lower oxygen concentration and a higher remanence than Comparative Example 1 in which the nitride was allowed to contact with pure water. It is also demonstrated that Examples 3 and 4 in which the magnetic powder obtained by contacting the nitride with an alkali solution was further subjected to acid treatment exhibited a much lower oxygen concentration and a much higher remanence than Examples 1 and 2. Moreover, these anisotropic magnetic powders had a narrow particle size distribution with a span of only about 1.04. Moreover, the difference between the oxygen concentration of Example 1 and that of Example 3 (0.76−0.36=0.4) was larger than the difference between the oxygen concentration of Comparative Example 1 and that of Example 1 (0.87−0.76=0.11), which demonstrates that the acid treatment has a larger effect in reducing the oxygen concentration than the alkali treatment.

### Example 5 (Middle Particle Size Magnetic Powder)

### Pretreatment Step

An amount of 100 g of the SmFe oxide obtained in Production Example 1 was put in a steel container to a thickness of 10 mm. The container was placed in a furnace, and the pressure was reduced to 100 Pa. Then, while introducing hydrogen gas, the temperature was increased to a pretreatment temperature of 850° C. and maintained at this temperature for 15 hours. The oxygen concentration was measured by non-dispersive infrared spectroscopy (ND-IR) (EMGA-820 available from Horiba Ltd.) and found to be 5% by mass. The results show that a black partial oxide was obtained in which the oxygen bonded to Sm remained unreduced while 95% of the oxygen bonded to Fe was reduced.

### Reduction Step

An amount of 60 g of the partial oxide obtained in the pretreatment step was mixed with 19.2 g of metallic calcium having an average particle size of about 6 mm, and the mixture was placed in a furnace. After vacuum evacuation of the furnace, argon gas (Ar gas) was introduced. The temperature was increased to a first temperature of 1,045° C. and maintained for 45 minutes, and then the temperature was lowered to a second temperature of 1,000° C. and maintained for 30 minutes, thereby obtaining Fe-Sm alloy particles.

### Nitridation Step

Subsequently, the temperature inside the furnace was lowered to 100° C., followed by vacuum evacuation. Then, while introducing nitrogen gas, the temperature was increased to 450° C. and maintained at this temperature for 23 hours, thereby obtaining a magnetic particle-containing bulk product.

### Water Washing Step

The bulk product obtained in the nitridation step was introduced into 3 kg of pure water and stirred for 30 minutes. After standing still, the supernatant was drained by decantation. The introduction into pure water, stirring, and decantation were repeated 10 times. Next, 2.5 g of 99.9% acetic acid was introduced and stirred for 15 minutes. After standing still, the supernatant was drained by decantation. The introduction into pure water, stirring, and decantation were repeated twice.

### Acid Treatment Step

To 100 parts by mass of the powder obtained in the nitridation step was added a 6% aqueous hydrochloric acid solution in an amount equivalent to 4.3 parts by mass of hydrogen chloride, and the mixture was stirred for 1 minute. After standing still, the supernatant was drained by decantation. The introduction into pure water, stirring, and decantation were repeated twice. After solid-liquid separation, vacuum drying was performed at 80° C. for 3 hours to obtain a magnetic powder.

### Examples 6 to 8 and Comparative Examples 2 to 5 (Middle Particle Size Magnetic Powders)

Magnetic powders were produced by the same procedure as in Example 5, except that the amount of the acid used was changed to the amounts shown in Table 3.

The magnetic powders obtained in the examples and comparative examples were measured for oxygen content, nitrogen content, and particle size distributions as described above. Table 3 shows the evaluation results.

TABLE 3

| | | | | Particle size distribution | | | | |
|---|---|---|---|---|---|---|---|---|
| | Amount of | O content | N content | Average | | | | Span |
| Example | (parts) | (% by | (% by | particle | | | | (D90-D10)/ |
| number | acid used | mass) | mass) | size (μm) | D10 | D50 | D90 | D50 |
| Comparative | 0 | 0.98 | 3.41 | 4.37 | 2.26 | 6.77 | 4.17 | 1.08 |
| Example 2 | | | | | | | | |
| Comparative | 2.3 | 0.75 | 3.20 | 3.56 | 1.60 | 3.26 | 5.72 | 1.26 |
| Example 3 | | | | | | | | |
| Comparative | 3.3 | 0.75 | 3.20 | 3.49 | 1.77 | 3.28 | 5.46 | 1.13 |
| Example 4 | | | | | | | | |
| Example 5 | 4.3 | 0.61 | 3.30 | 3.44 | 1.75 | 3.22 | 5.40 | 1.13 |
| Example 6 | 5.3 | 0.40 | 3.36 | 3.49 | 1.76 | 3.25 | 5.51 | 1.15 |
| Example 7 | 10.3 | 0.35 | 3.16 | 3.63 | 1.80 | 3.33 | 5.74 | 1.18 |
| Example 8 | 13.3 | 0.33 | 3.17 | 3.65 | 1.75 | 3.36 | 5.77 | 1.20 |
| Comparative | 15.3 | 0.73 | 3.30 | 3.63 | 1.72 | 3.24 | 5.70 | 1.23 |
| Example 5 | | | | | | | | |

As shown by the results in Table 3, when middle particle size magnetic powders were washed with at least 3.5 parts by mass but not more than 13.5 parts by mass of an acid, the resulting magnetic powders had a very low oxygen content of not higher than 0.61% by mass. These anisotropic magnetic powders also had a narrow particle size distribution with a span of only about 1.2.

### Examples 9 and 10 (Large Particle Size Magnetic Powders)

Large particle size magnetic powders were produced by the same procedure as in Example 5, except that the SmFe oxide prepared in Production Example 2 was used, and the amount of the acid used was changed to the amounts shown in Table 4. The magnetic powders obtained in the examples were measured for oxygen content, nitrogen content, and particle size distribution as described above. Table 4 shows the evaluation results.

TABLE 4

| | | | | Particle size distribution | | | | |
|---|---|---|---|---|---|---|---|---|
| | | | | Average | | | | |
| | Amount of | O content | N content | particle | | | | Span |
| Example | acid used | (% by | (% by | size | | | | (D90-D10)/ |
| number | (parts) | mass) | mass) | (μm) | D10 | D50 | D90 | D50 |
| Example 9 | 5 | 0.20 | 3.10 | 5.16 | 2.60 | 4.57 | 7.86 | 1.15 |
| Example 10 | 7 | 0.19 | 3.10 | 5.34 | 2.60 | 4.60 | 8.20 | 1.22 |

As shown by the results in Table 4, when large particle size magnetic powders were washed with 5 parts by mass or 7 parts by mass of an acid, the resulting magnetic powders had a very low oxygen content of not higher than 0.20% by mass. These anisotropic magnetic powders also had a narrow particle size distribution with a span of only about 1.2.

### Examples 11 to 13 and Comparative Example 6 (Small Particle Size Magnetic Powders)

Small particle size magnetic powders were produced by the same procedure as in Example 5, except that the SmFe oxide prepared in Production Example 3 was used, and the amount of the acid used was changed to the amounts shown in Table 5. The magnetic powders obtained in the examples and comparative example were measured for oxygen content, nitrogen content, and particle size distribution as described above. Table 5 shows the evaluation results.

TABLE 5

| | | | | Particle size distribution | | | | |
|---|---|---|---|---|---|---|---|---|
| | Amount of | O content | N content | Average | | | | Span |
| Example | acid used | (% by | (% by | particle | | | | (D90-D10)/ |
| number | (parts) | mass) | mass) | size (μm) | D10 | D50 | D90 | D50 |
| Example 11 | 4.3 | 0.54 | 3.30 | 2.47 | 0.90 | 2.18 | 4.17 | 1.50 |
| Example 12 | 10.3 | 0.45 | 3.27 | 2.50 | 0.91 | 2.22 | 4.19 | 1.48 |
| Example 13 | 13.3 | 0.41 | 3.25 | 2.61 | 1.04 | 2.37 | 4.37 | 1.41 |
| Comparative | 15.3 | 0.74 | 3.27 | 2.72 | 1.06 | 2.45 | 4.63 | 1.46 |
| Example 6 | | | | | | | | |

Similarly, as shown by the results in Table 5, when small particle size magnetic powders were washed with at least 3.5 parts by mass but not more than 13.5 parts by mass of an acid, the resulting magnetic powders had a very low oxygen content of not higher than 0.54% by mass. These anisotropic magnetic powders also had a narrow particle size distribution with a span of only about 1.5.

### Examples 14 and 15

Magnetic powders were produced by the same procedure as in Examples 9 and 11, respectively, except that the solids obtained after the solid-liquid separation in the acid treatment step were squeezed for dehydration and then vacuum dried at 80° C. for 3 hours. The magnetic powders obtained in the examples were measured for the moisture content of the solids after dehydration and the oxygen content, nitrogen content, and particle size distribution of the magnetic powder as described above. Table 6 shows the evaluation results together with the evaluation results of the magnetic powders produced in Examples 9 and 11.

TABLE 6

| | | | | Particle size distribution | | | | |
|---|---|---|---|---|---|---|---|---|
| | Moisture | | | Average | | | | |
| | content | O content | N content | particle | | | | Span |
| Example | (% by | (% by | (% by | size | | | | (D90-D10)/ |
| number | mass) | mass) | mass) | (μm) | D10 | D50 | D90 | D50 |
| Example 9 | 13.4 | 0.20 | 3.10 | 5.16 | 2.60 | 4.57 | 7.86 | 1.15 |
| Example 14 | 7.9 | 0.15 | 3.27 | 5.11 | 2.58 | 4.51 | 7.77 | 1.15 |
| Example 11 | 14.2 | 0.54 | 3.30 | 2.47 | 0.90 | 2.18 | 4.17 | 1.50 |
| Example 15 | 9.1 | 0.43 | 3.41 | 2.53 | 1.00 | 2.17 | 4.19 | 1.47 |

As shown by the results in Table 6, in Example 14, the moisture content was greatly reduced by dehydration, and the oxygen content of the prepared magnetic powder was further reduced as compared with Example 9. Similarly, in Example 15, the moisture content was greatly reduced, and the oxygen content of the prepared magnetic powder was further reduced as compared with Example 11.

### INDUSTRIAL APPLICABILITY

The anisotropic magnetic powder obtained by the production method according to the present invention has a low oxygen concentration, a small average particle size, a narrow particle size distribution, and a high remanence, and thus can be suitably applied particularly to sintered magnets.

What is claimed is:

1-5. (canceled)

6. A method for producing an anisotropic magnetic powder, comprising:
pretreating an oxide containing Sm and Fe by heat-treating the oxide in a reducing gas atmosphere to obtain a partial oxide;
heat-treating the partial oxide in the presence of a reducing agent to obtain alloy particles;
nitriding the alloy particles to obtain a nitride; and
treating the nitride with an alkali to obtain a magnetic powder.

7. The method for producing an anisotropic magnetic powder according to claim 6,
wherein the method further comprises treating the magnetic powder with an acid after the treating with the alkali.

8. The method for producing an anisotropic magnetic powder according to claim 7, wherein the acid comprises at least one of hydrogen chloride or nitric acid.

9. The method for producing an anisotropic magnetic powder according to claim 7,
wherein the method further comprises dehydrating the magnetic powder after the treating with the acid.

10. The method for producing an anisotropic magnetic powder according to claim 6,
wherein the treating with the alkali comprises treating the nitride with an aqueous solution containing calcium hydroxide or an aqueous solution containing sodium hydroxide.

11. A method for producing an anisotropic magnetic powder, comprising:
pretreating an oxide containing Sm and Fe by heat-treating the oxide in a reducing gas atmosphere to obtain a partial oxide;
heat-treating the partial oxide in the presence of a reducing agent to obtain alloy particles;
nitriding the alloy particles to obtain a composite containing magnetic particles and contaminants including at least one of Ca3N₂, CaO, and metallic calcium in a sintered bulk form; and
treating the composite with an alkali to obtain a magnetic powder.

12. The method for producing an anisotropic magnetic powder according to claim 11,
wherein the method further comprises treating the magnetic powder with an acid after the treating with the alkali.

13. The method for producing an anisotropic magnetic powder according to claim 12,
wherein the acid comprises at least one of hydrogen chloride or nitric acid.

14. The method for producing an anisotropic magnetic powder according to claim 12,
wherein the method further comprises dehydrating the magnetic powder after the treating with the acid.

15. The method for producing an anisotropic magnetic powder according to claim 11,
wherein the treating with the alkali comprises treating the composite with an aqueous solution containing calcium hydroxide or an aqueous solution containing sodium hydroxide.

16. An anisotropic magnetic powder having an average particle size of at least 1.5 μm but not more than 7 μm as measured with a laser diffraction-type particle size distribution analyzer under a dry condition,
wherein the powder has a span of not more than 1.6 as defined by the following equation:
Span=(D90−D10)/D50
wherein D10, D50, and D90 represent particle sizes corresponding to 10th, 50th, and 90th percentiles, respectively, in a cumulative particle size distribution by volume, and
wherein the powder comprises Sm, Fe, N, and O and has an O content of at least 0.05% by mass but not higher than 0.65% by mass.

17. The anisotropic magnetic powder according to claim 16,
wherein the average circularity of the anisotropic magnetic powder is not less than 0.75.

18. The method for producing an anisotropic magnetic powder according to claim 7,
wherein the acid is hydrogen chloride or nitric acid.

19. The method for producing an anisotropic magnetic powder according to claim 12,
wherein the acid is hydrogen chloride or nitric acid.
